(19) United States
(12) Patent Application Publication
(10) Pub. No.: US 2022/0058955 A1
(43) Pub. Date: Feb. 24, 2022

(54) APPARATUS AND METHOD FOR CONTROLLING PLATOONING INFORMATION OF VEHICLE

(71) Applicants: Hyundai Motor Company, Seoul (KR); Kia Corporation, Seoul (KR)

(72) Inventor: Se Young Park, Suwon (KR)

(21) Appl. No.: 17/318,650

(22) Filed: May 12, 2021

(30) Foreign Application Priority Data
Aug. 21, 2020 (KR) 10-2020-0105370

(51) Int. Cl. G08G 1/00; G08G 1/16; G06K 9/00; G07C 5/00; G07C 5/08

(52) U.S. Cl. CPC G08G 1/22; G08G 1/167; G07C 5/0816; G06K 9/00798; G07C 5/008; G06K 9/00805

(57) ABSTRACT

A platooning control apparatus is provided and includes a processor that separates platooning vehicle groups and creates new platooning vehicle groups when a situation occurs that requires separating the platooning vehicle groups during platooning of a leading vehicle and following vehicles. A storage stores data and algorithms driven by the processor. When an obstacle is detected in the platooning vehicle groups, the process performs in-lane avoidance control by determining whether in-lane avoidance of the following vehicles traveling behind the obstacle is possible.

### CROSS-REFERENCE TO RELATED APPLICATION

This application claims priority to and benefits of Korean Patent Application No. 10-2020-0105370 filed on Aug. 21, 2020, the entire contents of which are incorporated herein by reference.

### BACKGROUND

### (a) Field of the Disclosure

The present disclosure relates to a platooning control apparatus and a platooning control method, and more particularly, to an independent driving control of a platooning vehicle when a platooning separation factor occurs during platooning.

### (b) Description of the Related Art

Platooning is a technique for performing autonomous driving in a state in which a plurality of vehicles are disposed in a line at predetermined intervals. A leading vehicle, which is a vehicle positioned at a forefront of a platooning vehicle group, may control one or more following vehicles following the leading vehicle while performing platooning. The leading vehicle may maintain a gap between a plurality of vehicles included in a platooning vehicle group, and may exchange behavior and situation information of the vehicles included in the platooning vehicle group using inter-vehicle communication.

The above information disclosed in this section is merely for enhancement of understanding of the background of the disclosure, and therefore, it may contain information that does not form the prior art that is already known in this country to a person of ordinary skill in the art.

### SUMMARY

An exemplary embodiment of the present disclosure is to provide a platooning control apparatus and a platooning control method, capable of securing driving safety and maintaining a smooth traffic flow in an unexpected situation by determining a platooning separation condition during autonomous platooning driving.

The technical objects of the present disclosure are not limited to the objects mentioned above, and other technical objects not mentioned can be clearly understood by those skilled in the art from the description of the claims.

An exemplary embodiment of the present disclosure provides a platooning control apparatus that may include: a processor configured to separate platooning vehicle groups and generate new platooning vehicle groups when a situation that requires driving of separating the platooning vehicle groups occurs during platooning of a leading vehicle and following vehicles; and a storage configured to store data and algorithms driven by the processor. When an obstacle exists in the platooning vehicle groups, in-lane avoidance control may be performed by determining whether in-lane avoidance of the following vehicles traveling behind the obstacle is possible.

In an exemplary embodiment, the situation that requires driving of separating the platooning vehicle groups may include at least one of occurrence of obstacles in the platooning vehicle groups due to falling of a load of the following vehicle, a failure of a vehicle in the platooning vehicle group, and occurrence of nearby vehicles attempting to change to a lane in which the platooning vehicle groups are driving. The processor may be configured to determine whether the in-lane avoidance control is possible based on a position and size of the obstacle.

In addition, the processor may be configured to determine whether lane change is possible when the in-lane avoidance control is impossible. The processor may be configured to determine whether lateral control is required when the lane change is possible. The processor may also be configured to determine that the lateral control is required when avoidance control is not possible through in-lane acceleration/deceleration control or a vehicle speed decreases below a predetermined speed due to the obstacle.

Further, the processor may be configured to determine whether an existing platooning vehicle group exists in a lateral control-direction lane when the lateral control is required. In an exemplary embodiment, the processor may be configured to add the existing platooning vehicle group to the new platooning vehicle group when the existing platooning vehicle group exists in the lateral control-direction lane. The processor may allow the new platooning vehicle group to perform lane change when no existing platooning vehicle group exists in the lateral control-direction lane.

Additionally, the processor may be configured to perform the lateral control through acceleration/deceleration control at a time when the lane change is possible in a case where the lane change is impossible. The processor may be configured to perform the lateral control through acceleration/deceleration control at a time when the lane change is possible in a case where the lane change is possible but lateral control is not required. The processor may be configured to exclude a vehicle that has failed from the platooning vehicle group when the failing vehicle is separated from the platooning vehicle group due to the failure. In addition, the processor may be configured to determine a size of the platooning vehicle groups divided depending on a number of lanes occupied by the obstacle.

An exemplary embodiment of the present disclosure provides a platooning control method that may include: determining whether a situation that requires driving of separating platooning vehicle groups occurs during platooning of a leading vehicle and following vehicles; separating platooning vehicle groups and generating new platooning vehicle groups when the situation that requires the driving of separating the platooning vehicle groups occurs; and performing in-lane avoidance by determining whether the following vehicles traveling behind an obstacle are able to avoid the obstacle within a lane when the obstacle exists in the platooning vehicle groups.

In an exemplary embodiment, the performing of the in-lane avoidance control may include determining whether the in-lane avoidance control is possible based on a position and size of the obstacle. The method may further include: determining whether lane change is possible when the in-lane avoidance control is impossible; and determining whether lateral control is necessary when the lane change is possible. In an exemplary embodiment, the determining of whether the lateral control is necessary may include determining that the lateral control is required when avoidance control is not possible through in-lane acceleration/deceleration control or a vehicle speed decreases below a predetermined speed due to the obstacle.

The method may further include: determining whether an existing platooning vehicle group exists in a lateral control-direction lane when the lateral control is required; adding the existing platooning vehicle group to the new platooning vehicle group when the existing platooning vehicle group exists in the lateral control-direction lane; and allowing the new platooning vehicle group to perform lane change when no existing platooning vehicle group exists in the lateral control-direction lane. In addition, the method may further include performing the lateral control through acceleration/deceleration control at a time when the lane change is possible in a case where the lane change or the lateral control is impossible. The generating of the new platooning vehicle group may include determining a size of the platooning vehicle groups divided depending on a number of lanes occupied by the obstacle.

This technique may secure driving safety and maintain a smooth traffic flow in an unexpected situation by determining a platooning separation condition during autonomous platooning driving. In addition, various effects that may be directly or indirectly identified through this document may be provided.

### BRIEF DESCRIPTION OF THE DRAWINGS

The objects, features and advantages of the present invention will be more apparent from the following detailed description in conjunction with the accompanying drawings, in which:

FIG. 1 illustrates a block diagram showing a configuration of a vehicle system including a platooning control apparatus according to an exemplary embodiment of the present disclosure.

FIG. 2 illustrates an example of a screen showing new addition of platooning vehicle group and independent driving control during platooning according to an exemplary embodiment of the present disclosure.

FIG. 3 illustrates a platooning control method according to an exemplary embodiment of the present disclosure.

FIG. 4 illustrates a computing system according to an exemplary embodiment of the present disclosure.

### DETAILED DESCRIPTION

Hereinafter, some exemplary embodiments of the present disclosure will be described in detail with reference to exemplary drawings. It should be noted that in adding reference numerals to constituent elements of each drawing, the same constituent elements have the same reference numerals as possible even though they are indicated on different drawings. In addition, in describing exemplary embodiments of the present disclosure, when it is determined that detailed descriptions of related well-known configurations or functions interfere with understanding of the exemplary embodiments of the present disclosure, the detailed descriptions thereof will be omitted.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Furthermore, control logic of the present disclosure may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In describing constituent elements according to an exemplary embodiment of the present disclosure, terms such as first, second, A, B, (a), and (b) may be used. These terms are only for distinguishing the constituent elements from other constituent elements, and the nature, sequences, or orders of the constituent elements are not limited by the terms. In addition, all terms used herein including technical scientific terms have the same meanings as those which are generally understood by those skilled in the technical field to which the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

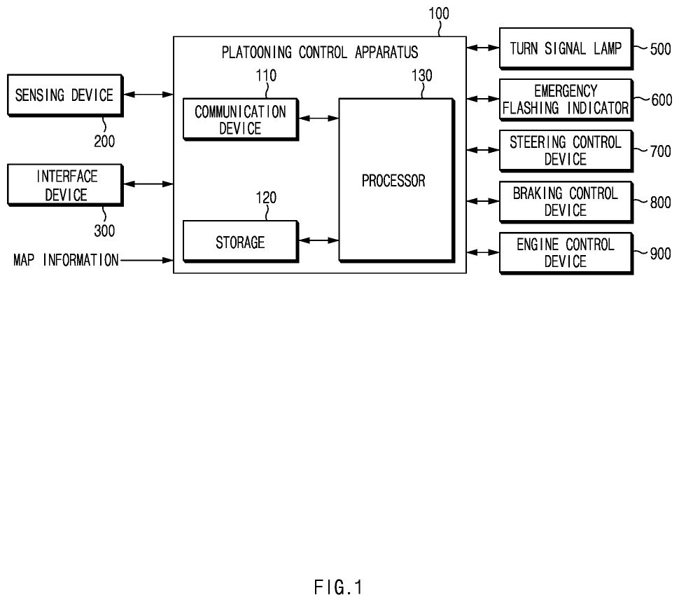

The present disclosure discloses a technique for performing independent driving control by separating platooning vehicle groups when a situation in which separation of the platooning vehicle groups is required depending on an internal factor or an external factor occurs during platooning. Hereinafter, exemplary embodiments of the present disclosure will be described in detail with reference to FIG. 1 to FIG. 4.

A leading vehicle LV and following vehicles FV included in a platooning vehicle group may perform platooning on a road. The leading vehicle LV and the following vehicles FV may be driven while maintaining a predetermined distance therebetween. While driving, the leading vehicle LV or the following vehicles FV may adjust a distance between the leading vehicle LV and the following vehicles FV. The leading vehicle LV or the following vehicles FV may increase or decrease an inter-vehicle distance based on driver manipulation. The FV may include one or more vehicles that are being driven behind the leading vehicle LV.

FIG. 1 illustrates a block diagram showing a configuration of a vehicle system including a platooning control apparatus according to an exemplary embodiment of the present disclosure. Referring to FIG. 1, according to an exemplary embodiment of the present disclosure, the platooning control apparatus 100 may be implemented inside a vehicle. In particular, the platooning driving control apparatus 100 may be integrally formed with internal controllers of the vehicle, or may be implemented as a separate device to be connected to controllers of the vehicle by a separate connection.

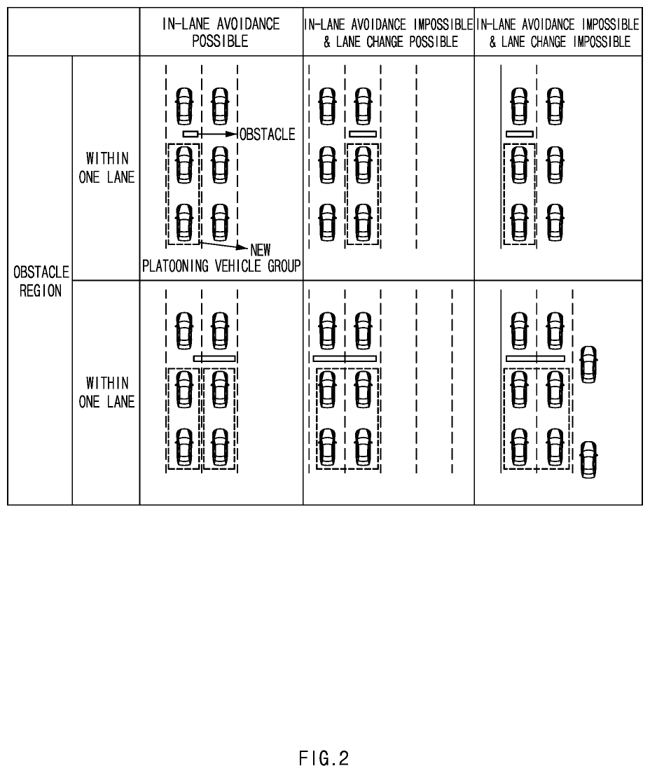

Referring to FIG. 2, the vehicle system may include the platooning driving control apparatus 100, a sensing device 200, an interface device 300, a turn signal lamp 500, an emergency flashing indicator 600, a steering control device 700, a braking control device 800, and an engine control device 900. The platooning control apparatus 100 may be configured to continuously perform platooning by separating platooning vehicle groups and generate new platooning vehicle groups when a situation that requires driving of separating the platooning vehicle groups due to the occurrence of obstacles or the like occurs during platooning of platooning vehicles. Particularly, a first following vehicle positioned at the forefront among the following vehicles traveling behind the obstacle may become a new leading vehicle in a new platooning vehicle group.

Subsequently, the platooning control apparatus 100 of the new leading vehicle may be configured to operate to avoid obstacles or the like. In particular, the requirement of separating the platooning vehicle groups may include at least one of obstacles being detected in the platooning vehicle groups due to falling of a load of the following vehicle (e.g., something falls off one of the vehicles), a failure of a vehicle in the platooning vehicle group, occurrence of nearby vehicles attempting to change to a lane in which the platooning vehicle group is driving, or the like.

According to the present exemplary embodiment, the platooning control apparatus 100 which is operated as the above may be implemented in a form of an independent hardware device including a memory and a processor that processes each operation, and may be driven in a form included in other hardware devices such as a microprocessor or a general purpose computer system. The platooning control apparatus 100 may include a communication device 110, a storage 120, and a processor 130.

The communication device 110, which is a hardware device implemented with various electronic circuits to transmit and receive signals via a wireless or wired connection, may be configured to perform V2I communication using an in-vehicle network communication technique or a wireless Internet access or short range communication technique with servers, infrastructure, and other vehicles outside the vehicle in the present disclosure. Herein, in-vehicle communication may be performed through controller area network (CAN) communication, local interconnect network (LIN) communication, or flex-ray communication as the in-vehicle network communication technique. In addition, the wireless communication technique may include wireless LAN (WLAN), wireless broadband (Wibro), Wi-Fi, world Interoperability for microwave access (Wimax), etc. In addition, short-range communication technique may include bluetooth, ZigBee, ultra wideband (UWB), radio frequency identification (RFID), infrared data association (IrDA), and the like.

As an example, the communication unit 110 may be configured to share platooning information among vehicles in the platooning vehicle group. In particular, the platooning information may include deviation from the platooning vehicle group, generation of a new platooning vehicle group, position, speed, and destination information of the vehicle, and the like. The storage 120 may be configured to store sensing results of the sensing device 200, vehicle information of vehicles in the platooning vehicle group received by the communication device 110, data obtained by the processor 130, data and/or algorithms necessary for the vehicle integrated control apparatus 130 to operate, and the like.

As an example, the storage 120 may be configured to store position information of a vehicle, information of a road ahead, and position information of a traffic light in front, received through a navigation or the like. In addition, the storage 120 may be configured to store positioning information, vehicle speed information, and the like of a front vehicle received via V2X communication. The storage 120 may also be configured to store information related to a front obstacle, e.g., a vehicle in front, sensed by the sensing device 200.

Further, the storage device 120 may be configured to store position and size information of an obstacle acquired by the sensing device 200, a position and speed information of a surrounding vehicle, etc., and store commands and/or algorithms for independent driving control, etc. The storage 120 may include a storage medium of at least one type among memories of types such as a flash memory, a hard disk, a micro, a card (e.g., a secure digital (SD) card or an extreme digital (XD) card), a random access memory (RAM), a static RAM (SRAM), a read-only memory (ROM), a programmable ROM (PROM), an electrically erasable PROM (EEPROM), a magnetic memory (MRAM), a magnetic disk, and an optical disk.

The processor 130 may be electrically connected to the communication device 110, the storage 120, and the like, may electrically control each component, and may be an electrical circuit that executes software commands, thereby performing various data processing and calculations described below. The processor 130 may be, e.g., an electronic control unit (ECU), a micro controller unit (MCU), or other subcontrollers mounted in the vehicle. The processor 130 may be configured to separate platooning vehicle groups and generate new platooning vehicle groups when a situation that requires separation of the platooning vehicle groups occurs during platooning of the leading vehicle and the following vehicles.

When an obstacle exists or is detected in the platooning vehicle groups, the processor 130 may be configured to perform in-lane avoidance by determining whether the following vehicles traveling behind the obstacle is capable of avoiding the obstacle while remaining within a lane. The processor 130 may be configured to determine whether in-lane avoidance control is possible based on the position and size of the obstacle. FIG. 2 illustrates an example of a screen showing new addition of platooning vehicle group and independent driving control during platooning according to an exemplary embodiment of the present disclosure.

Referring to FIG. 2, when the position of the obstacle is biased to a side of a driving lane and the vehicle may be driven next to the obstacle within the lane since the size of the obstacle is small, the in-lane avoidance control is possible. In addition, the processor 130 may be configured to determine the size of the platooning vehicle groups divided based on a number of lanes occupied by the obstacle. In FIG. 2, when the obstacle occupies only a first lane, the new platooning vehicle group may include one row including the following vehicles behind the obstacle. In addition, when the obstacle occupies only the first lane, a case where it is impossible to avoid the obstacle while remaining within the lane, but a change into a right lane is possible and a case where it is impossible to avoid the obstacle while remaining within the lane and lane change is impossible are illustrated.

However, when the obstacle occupies or is detected in both the first lane and a second lane, the new platooning vehicle group may include both first and second rows. In other words, as illustrated in FIG. 2, for the new platooning vehicle group, the new platooning vehicle group of two rows including vehicles following an obstacle may be created or generated, or two new platooning vehicle groups each of which has one row may be created or generated.

The processor 130 may be configured to determine whether lane change is possible based on whether a nearby vehicle is present in a proximate lane when the in-lane avoidance control is not possible due to the size of the obstacle or the position of the obstacle is positioned in a center of the lane as illustrated in FIG. 2. The processor 130 may be configured to determine that lane change is possible when there is no nearby vehicle in the next or proximate lane. The processor 130 may be configured to determine whether lateral control is required when the lane change is possible. In other words, the processor 130 may be configured to determine that the lateral control is required when avoidance control is not possible through in-lane acceleration/deceleration control or a vehicle speed decreases to less than a predetermined speed due to the obstacle.

The processor 130 may be configured to determine whether an existing platooning vehicle group exists in a lateral control-direction lane, when the lateral control is required, and add the existing platooning vehicle group to the new platooning vehicle group when the existing platooning vehicle group exists in the lateral control-direction lane. On the other hand, the processor 130 may be configured to avoid the obstacle by allowing the new platooning vehicle group to perform lane change when no existing platooning vehicle group exists in the lateral control-direction lane.

Additionally, the processor 130 may be configured to perform lateral control at a time when the lane change is possible through acceleration/deceleration control in a case where the lane change is not possible or when the lane change is possible but the lateral control is not required. The processor 130 may be configured to exclude a vehicle that has failed from the platooning vehicle group when the failing vehicle is separated from the platooning vehicle group due to the failure.

The sensing device 200 may include a vehicle external information sensor configured to sense external information of the vehicle, and a vehicle internal information sensor configured to sense internal information of the vehicle. The sensing device 200 may include one or more sensors configured to sense an obstacle, e.g., a preceding vehicle, positioned around the host vehicle and measure a distance with the obstacle and/or a relative speed thereof.

The sensing device 200 may include a plurality of sensors configured to sense an external object of the vehicle, obtain information related to a position of the external object, a speed of the external object, a moving direction of the external object, and/or a type of the external object (e.g., vehicles, pedestrians, bicycles or motorcycles, etc.). Accordingly, the sensing device 200 may include an ultrasonic sensor, a radar, a camera, a laser scanner, and/or a corner radar, a LIDAR, an acceleration sensor, a yaw rate sensor, a torque measurement sensor and/or a wheel speed sensor, a steering angle sensor, etc.

The interface device 300 may include an input device for receiving a control command from a user and an output device for outputting an operation state of the apparatus 100 and results thereof. Herein, the input device may include a key button, and may include a mouse, a joystick, a jog shuttle, a stylus pen, and the like. In addition, the input device may include a soft key implemented on the display.

The output device may include a display, and may also include a voice output such as a speaker. In particular, when a touch sensor formed of a touch film, a touch sheet, or a touch pad is provided on the display, the display may operate as a touch screen, and may be implemented in a form in which an input device and an output device are integrated. The display may include at least one of a liquid crystal display (LCD), a thin film transistor liquid crystal display (TFT LCD), an organic light emitting diode display (OLED display), a flexible display, a field emission display (FED), and a 3D display.

As an example, the output device may be configured to display platooning information. In particular, the platooning information may include information related to platooning changes such as creating and releasing (or separating) of platooning vehicle groups, and information related to creation of a new platooning vehicle group, an obstacle in front, an avoidance path, a lane change path, and the like. The turn signal lamp 500 may be operated to be turned on by the platooning control apparatus 100 when a lane is changed. In other words, the turn signal lamp 500 positioned in a direction to be changed may be turned on.

The emergency flashing indicator 600 may provide a notification to a following vehicle by flashing an emergency light in a dangerous situation. The steering control device 700 may be configured to adjust a steering angle of a vehicle, and may include a steering wheel, an actuator interlocked with the steering wheel, and a controller configured to operate the actuator. The braking control device 800 may be configured to adjust braking of the vehicle, and may include a controller configured to operate a brake thereof. The engine control device 900 may be configured to adjust engine driving of a vehicle, and may include a controller configured to adjust a speed of the vehicle.

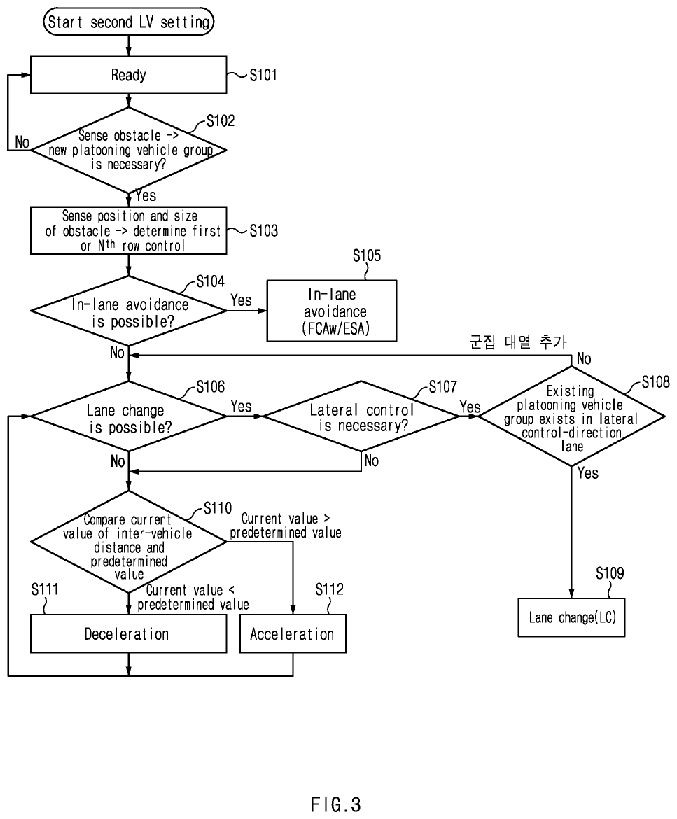

Hereinafter, a platooning control method according to an exemplary embodiment of the present disclosure will be described in detail with reference to FIG. 3. FIG. 3 illustrates a flowchart showing a platooning control method according to an exemplary embodiment of the present disclosure, and shows a method of determining occurrence of a platooning vehicle group separation situation and creating a new platooning vehicle group to control it to drive independently.

Hereinafter, it is assumed that the platooning control apparatus 100 of the of FIG. 1 performs processes of FIG. 3. In addition, in the description of FIG. 3, operations described as being performed by a device may be understood as being controlled by the processor 130 of the platooning control apparatus 100 mounted in a following vehicle. When the platooning vehicle group separation situation occurs, all following vehicles excluding a current group leader vehicle become a new group leader vehicle.

Referring to FIG. 3, the platooning control apparatus 100 of a following vehicle always maintains a ready state (S101). The platooning control apparatus 100 of the following vehicle may be configured to continuously detect a surrounding obstacle using the sensing device 200 to determine whether the platooning vehicle group separation situation occurs (whether it is necessary to create a new platooning vehicle group) (S102).

In particular, the platooning vehicle group separation situation indicates a situation in which a new platooning vehicle group needs to be formed depending on a vehicle internal factor or a vehicle external factor. For example, the vehicle internal factor may include occurrence or detection of obstacles in the platooning vehicle group due to falling of a load from a following vehicle, and occurrence of a driving problem or failure of a specific vehicle belonging to the platooning vehicle group. In addition, the vehicle external factor may include lane change of a nearby vehicle to a lane in which the platooning vehicle group is traveling, occurrence of an obstacle caused by other external factors, and the like.

Accordingly, when a nearby vehicle attempts to rapidly change to a lane in which the platooning vehicle group is traveling, it is difficult to uniformly control the platooning vehicle group due to presence of an obstacle such as a load in the platooning vehicle group, or a traffic flow is unfavorable, and thus, the platooning control apparatus 100 may be configured to determine a current situation as the platooning vehicle group separation situation (in which it is necessary to create a new platooning vehicle group).

When it is necessary to create or generate the new platooning vehicle group, the platooning control apparatus 100 may be configured to create the new platooning vehicle group based on a position of the obstacle and a size of the obstacle. In other words, as illustrated in FIG. 2, the platooning control apparatus 100 may include a row of vehicles positioned in the rear based on the position of the obstacle in the new platooning vehicle group. In addition, as illustrated in FIG. 2, the platooning control apparatus 100 may be configured to set a first row or a N^{th} row as the new platooning vehicle group depending on a number of lanes occupied by the obstacle.

After creating a new platooning vehicle group, the platooning control apparatus 100 may be configured to determine whether in-lane avoidance control is possible (S104), and perform the in-lane avoidance control when it is possible. In particular, the platooning control apparatus 100 may be configured to determine that the in-lane avoidance control is possible when the obstacle is positioned in a portion of the lane but a size of the obstacle is small enough for vehicles to be driven through remaining portions of the lane. In other words, when the in-lane avoidance control is possible, the platooning control apparatus 100 may be configured to determine that only a corresponding row of vehicles is in need of lateral control within the lane, to perform the lateral control through a forward collision-avoidance assist (FCAw) function, an emergency steer assist (ESA) function, or the like.

On the other hand, when in-lane avoidance control is impossible, the platooning control apparatus 100 may be configured to determine whether lane change is possible (S106). In particular, the platooning control apparatus 100 may be configured to determine that the in-lane avoidance control is impossible when the size of the obstacle is too large for vehicles to be driven through a region where there is no obstacle within the lane or when the obstacle is positioned in a center of the lane to block driving of vehicles to a region where there is no obstacle in the lane.

In addition, the platooning control apparatus 100 may be configured to determine that lane change is possible when there is no vehicle traveling or no obstacle in a next lane. When the lane change is possible, the platooning control apparatus 100 may be configured to determine whether lateral control is required (S107). The platooning control apparatus 100 may be configured to perform lateral control using a lane change assist control function of highway driving assist (HDA) 2.

The cluster driving control apparatus 100 may be configured to determine that the lateral control is required when avoidance control is impossible only by acceleration/deceleration within a lane or when an obstacle falls more than a predetermined reference speed compared to an existing driving speed. For example, it may be determined that lateral control is necessary when decelerating more than about 30 km/h. In addition, the platooning control apparatus 100 may be configured to determine that lateral control is necessary as a method to avoid an abnormal traffic situation.

In response to determining that lateral control is necessary, the platooning control apparatus 100 may be configured to determine whether an existing platooning vehicle group exists in a lane in a direction moving by the lateral control (S108). The platooning control apparatus 100 may be configured to control a new platooning vehicle group to perform lane change when the existing platooning vehicle group does not exist in the lane in the direction moving by the lateral control (S109).

The platooning control apparatus 100 may be configured to add the existing platooning vehicle group to the new platooning vehicle group, and determine whether lane change is possible again when there is the existing platooning vehicle group in the lane in the direction moving by the lateral control (S106). Particularly, for driving safety, it is possible to limit rows of vehicles that can simultaneously change lanes. For example, when changing lanes, lateral control may be enabled for up to two rows at the same time.

On the other hand, in response to determining that it is impossible to change lanes in step S106 or the lateral control is not necessary in the step S108, the platooning control apparatus 100 may be configured to control a new platooning vehicle group to be driven while maintaining a predetermined inter-vehicle distance, and compare a current value of the inter-vehicle distance with a predetermined value (S110). In other words, the platooning control apparatus 100 may be configured to monitor a surrounding situation while performing acceleration/deceleration control on a corresponding vehicle row to perform lateral control at a time when lane change is possible in a case where in-lane avoidance is impossible and the lane change is impossible.

The cluster driving control apparatus 100 may be configured to decelerate the vehicle when the current value of the inter-vehicle distance is less than the predetermined value (S111), and accelerate the vehicle when the current value of the inter-vehicle distance is greater than the predetermined value (S112). As described above, the present disclosure determines the platooning vehicle group separation situation based on actual driving conditions, such as the position of the obstacle, whether lateral control is required, or the like, creates a new platooning vehicle group in a short time and separates the platooning vehicle groups to avoid the obstacle, to ensure driving safety and maintain a smooth traffic flow.

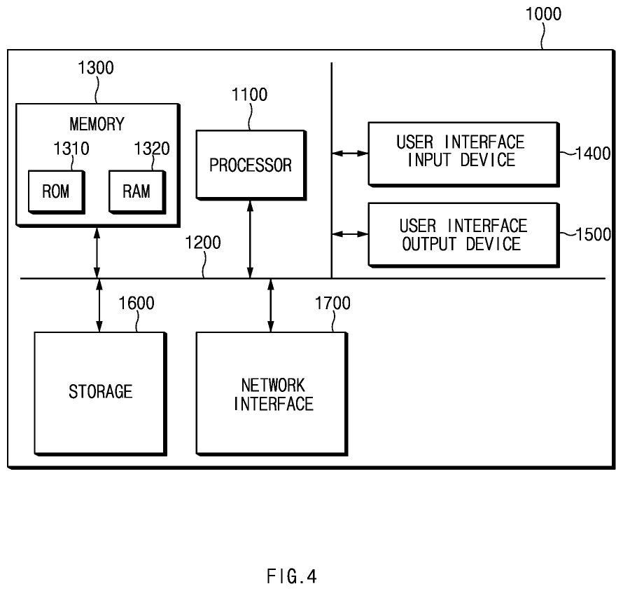

FIG. 4 illustrates a computing system according to an exemplary embodiment of the present disclosure. Referring to FIG. 4, the computing system 1000 may include at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that performs processing on commands stored in the memory 1300 and/or the storage 1600. The memory 1300 and the storage 1600 may include various types of volatile or nonvolatile storage media. For example, the memory 1300 may include a read only memory (ROM) and a random access memory (RAM). Accordingly, steps of a method or algorithm described in connection with the exemplary embodiments disclosed herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific integrated circuit (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments disclosed in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A platooning control apparatus, comprising:
a processor configured to separate platooning vehicle groups and create new platooning vehicle groups in response to detecting a situation that requires separation of the platooning vehicle groups during platooning of a leading vehicle and following vehicles; and
a storage configured to store data and algorithms driven by the processor,
wherein in response to detecting an obstacle in the platooning vehicle groups, the processor is configured to perform in-lane avoidance control by determining whether in-lane avoidance of the following vehicles traveling behind the obstacle is possible.

2. The platooning control apparatus of claim 1, wherein the situation that requires separation of the platooning vehicle groups occurs includes:
at least one of a detection of obstacles in the platooning vehicle groups, a failure of vehicles in the platooning vehicle groups, and an occurrence of nearby vehicles attempting to change to a lane in which the platooning vehicle groups are driving.

3. The platooning control apparatus of claim 1, wherein the processor is configured to determine whether the in-lane avoidance control is possible based on a position and a size of the obstacle.

4. The platooning control apparatus of claim 1, wherein the processor is configured to determine whether lane change is possible when the in-lane avoidance control is impossible.

5. The platooning control apparatus of claim 4, wherein the processor is configured to determine whether lateral control is required when the lane change is possible.

6. The platooning control apparatus of claim 4, wherein the processor is configured to determine that the lateral control is required when avoidance control is impossible through in-lane acceleration/deceleration control or a vehicle speed decreases to less than a predetermined speed due to the obstacle.

7. The platooning control apparatus of claim 5, wherein the processor is configured to determine whether an existing platooning vehicle group is present in a lateral control-direction lane when the lateral control is required.

8. The platooning control apparatus of claim 7, wherein the processor is configured to add the existing platooning vehicle group to the new platooning vehicle group when the existing platooning vehicle group is present in the lateral control-direction lane.

9. The platooning control apparatus of claim 7, wherein the processor is configured to allow the new platooning vehicle group to perform lane change when no existing platooning vehicle group is present in the lateral control-direction lane.

10. The platooning control apparatus of claim 4, wherein the processor is configured to perform the lateral control through acceleration/deceleration control at a time when the lane change is possible in a case where the lane change is impossible.

11. The platooning control apparatus of claim 5, wherein in response to determining that the lane change is possible but lateral control is not required, the processor is configured to perform the lateral control through acceleration/deceleration control at a time when the lane change is possible.

12. The platooning control apparatus of claim 1, wherein the processor is configured to exclude a vehicle that has failed from the platooning vehicle group when the failing vehicle is separated from the platooning vehicle group due to the failure.

13. The platooning control apparatus of claim 1, wherein the processor is configured to determine a size of the platooning vehicle groups divided based on a number of lanes occupied by the obstacle.

14. A platooning control method, comprising:
determining, by a processor, whether a situation requires separation of platooning vehicle groups during platooning of a leading vehicle and following vehicles;
separating, by the processor, platooning vehicle groups and creating new platooning vehicle groups when the situation requires the separation the platooning vehicle groups occurs; and
performing, by the processor, in-lane avoidance by determining whether the following vehicles traveling behind an obstacle are capable of avoiding the obstacle within a lane when the obstacle is detected in the platooning vehicle groups.

15. The platooning control method of claim 14, wherein the performing of the in-lane avoidance control includes determining whether the in-lane avoidance control is possible based on a position and a size of the obstacle.

16. The platooning control method of claim 14, further comprising:
determining, by the processor, whether lane change is possible when the in-lane avoidance control is impossible; and
determining, by the processor, whether lateral control is necessary when the lane change is possible.

17. The platooning control method of claim 16, wherein the determining of whether the lateral control is necessary includes determining that the lateral control is required when avoidance control is impossible through in-lane acceleration/deceleration control or a vehicle speed decreases to less than a predetermined speed due to the obstacle.

18. The platooning control method of claim 16, further comprising:
determining, by the processor, whether an existing platooning vehicle group is present in a lateral control-direction lane when the lateral control is required;
adding, by the processor, the existing platooning vehicle group to the new platooning vehicle group when the existing platooning vehicle group is present in the lateral control-direction lane; and
allowing, by the processor, the new platooning vehicle group to perform lane change when no existing platooning vehicle group is present in the lateral control-direction lane.

19. The platooning control method of claim 18, further comprising
performing, by the processor, the lateral control through acceleration/deceleration control at a time when the lane change is possible in a case where the lane change or the lateral control is impossible.

20. The platooning control method of claim 14, wherein the creating of the new platooning vehicle group includes determining a size of the platooning vehicle groups divided based on a number of lanes occupied by the obstacle.
